(19) United States
(12) Patent Application Publication
(10) Pub. No.: US 2008/0122992 A1
(43) Pub. Date: May 29, 2008

(54) Sequential Display With Motion Adaptive Processing for a Dmd Projector

(75) Inventor: Donald Henry Willis, Indianapolis, IN (US)

Correspondence Address: Joseph J. Laks;Thomson Licensing LLC, 2 Independence Way, Patent Operations, PO Box 5312, PRINCETON, NJ, 08543, US

(73) Assignees: THOMSON LICENSING S.A., Boulogne-Billancout (FR); THOMSON LICENSING, Boulogne-Biliancourt (FR)

(21) Appl. No.: 11/883,041

(22) PCT Filed: Jan. 28, 2005
(86) PCT No.: PCT/US05/03517

§ 371 Date: Jul. 25, 2007

(51) Int. Cl. H04N 5/74

(52) U.S. Cl. 348/771; 348/E05.137

(57) ABSTRACT

Within a sequential display system, an apparatus performs motion adaptive processing of a pixel signal that controls the illumination of a corresponding pixel. The apparatus determines from the pixel signal whether motion has occurred for at least a predetermined duration. If not, the apparatus processes the pixel signal to cause a substantially uniform distribution of illumination throughout the picture period for the associated pixel. Otherwise, if motion has occurred for more than the predetermined duration, the apparatus processes the pixel signal to cause a substantial confinement of illumination to a limited interval of the picture period.

### TECHNICAL FIELD

This invention relates to a technique for operating a sequential display to reduce artifacts.

### BACKGROUND ART

There presently exist television projection systems that utilize a type of semiconductor device known as a Digital Micromirror Device (DMD). A typical DMD comprises a plurality of individually movable micromirrors arranged in a rectangular array. Each micromirror pivots about a limited arc, typically on the order of 10°-12° under the control of a corresponding driver cell that latches a bit therein. Upon the application of a previously latched “1” bit, the driver cell causes its associated micromirror to pivot to a first position. Conversely, the application of a previously latched “0” bit to the driver cell causes the driver cell to pivot its associated micromirror to a second position. By appropriately positioning the DMD between a light source and a projection lens, each individual micromirror of the DMD device, when pivoted by its corresponding driver cell to the first position, will reflect light from the light source through the lens and onto a display screen to illuminate an individual picture element (pixel) in the display. When pivoted to its second position, each micromirror reflects light away from the display screen, causing the corresponding pixel to appear dark. An example of such DMD device is the DMD of the DLP™ system available from Texas Instruments, Dallas Tex.

Present day television projection systems that incorporate a DMD of the type described control the brightness (illumination) of the individual pixels by controlling the interval during which the individual micromirrors remain “on” (i.e., pivoted to their first position), versus the interval during which the micromirrors remain “off” (i.e. pivoted to their second position), hereinafter referred to as the micromirror duty cycle. To that end, such present day DMD-type projection systems typically use pulse width modulation to control the pixel brightness by varying the duty cycle of each micromirror in accordance with the state of the pulses in a sequence of pulse width segments. Each pulse width segment comprises a string of pulses of different time duration. The actuation state of each pulse in a pulse width segment (i.e., whether each pulse is turned on or off) determines whether the micromirror remains on or off, respectively, for the duration of that pulse. In other words, the larger the sum of the total widths of the pulses in a pulse width segment that are turned on (actuated) during a picture interval, the longer the duty cycle of the micromirror associated with such pulses and the higher the pixel brightness during such interval.

In television projection systems utilizing such a DMD, the picture period, i.e., the time between displaying successive images, depends on the selected television standard. The NTSC standard currently in use in the United States employs a picture period (frame interval) of 1/60 second whereas certain European television standards (e.g., PAL) employ a picture period of 1/50 second. Present day DMD-type television projection systems typically provide a color display by projecting red, green, and blue images either simultaneously or in sequence during each picture interval. A typical sequential DMD-type projection system utilizes a color changer, typically in the form of a motor-driven color wheel, interposed in the light path of the DMD. The color wheel has a plurality of separate primary color windows, typically red, green and blue, so that during successive intervals, red, green, and blue light, respectively, falls on the DMD.

As described, the combination of the DMD and the color wheel implement a sequential color display. In order to minimize the color breakup artifact of the sequential display, the color sequence appears multiple times per incoming picture. Thus, the color wheel must change the DMD illumination color multiple times during each picture interval. For example, a DMD-type television set that changes the illumination color 12 times per picture interval will display each of three primary colors four times per incoming picture, thus yielding a so-called 4× display.

A multiple segment display of the type described above can suffer from several different types of motion artifacts. One such artifact is “motion blurring” which occurs when a moving object appears to spread across the display screen. Past solutions have sought to limit low brightness objects to one or two segments per color. Rather than represent a low brightness object by actuating pulses in most or all of the segments per color, only the pulses in one or two segments become actuated in an effort to confine the brightness to a limited portion of the picture interval. Unfortunately, this approach only works well for low brightness objects because higher brightness objects cannot be confined to one or two segments per color. Moreover, confining an object, even a low brightness object, to one or two segments per color will increase color breakup caused by viewer eye motion

Thus, a need exists for a technique for reducing such motion artifacts while limiting color break-up due only to eye motion.

### BRIEF SUMMARY OF THE INVENTION

Briefly, in accordance with the present principles, there is provided a method for operating a color sequential display system having at least one pixel controlled by a pixel signal that determines pixel illumination during each of a plurality of segments of a picture period. The method commences by first determining from the pixel signal whether motion has occurred. If so, the pixel signal undergoes processing to initially substantially confine the change in illumination to a limited number of time-adjacent segments of the same color to reduce motion blurring. Confining the change in illumination to a limited interval during the picture period in the presence of motion reduces the incidence of motion blurring. In the absence of motion for more than a predetermined duration, the pixel signal undergoes processing to cause a substantially uniform distribution of illumination throughout the picture period for the associated pixel. Spreading the illumination substantially equally throughout the picture period minimizes color break-up with random, large and fast eye motion.

### BRIEF DESCRIPTION OF THE DRAWINGS

FIG. 1 depicts a block schematic diagram of a present-day color sequential display system;

FIG. 2 depicts a frontal view of the color wheel comprising part of the color sequential modulated system display of FIG. 1;

FIG. 3 depicts an apparatus in accordance with the present principles for processing a pixel signal within the sequential display system of FIG. 1 to control the distribution of illumination for responsive to motion to reduce motion artifacts;

FIG. 4 depicts a 4× sequential display of picture segments produced by the system of FIG. 1; and

FIGS. 5-7 collectively depict a table of segment values demonstrating the operation of the system of FIG. 3.

### DETAILED DESCRIPTION

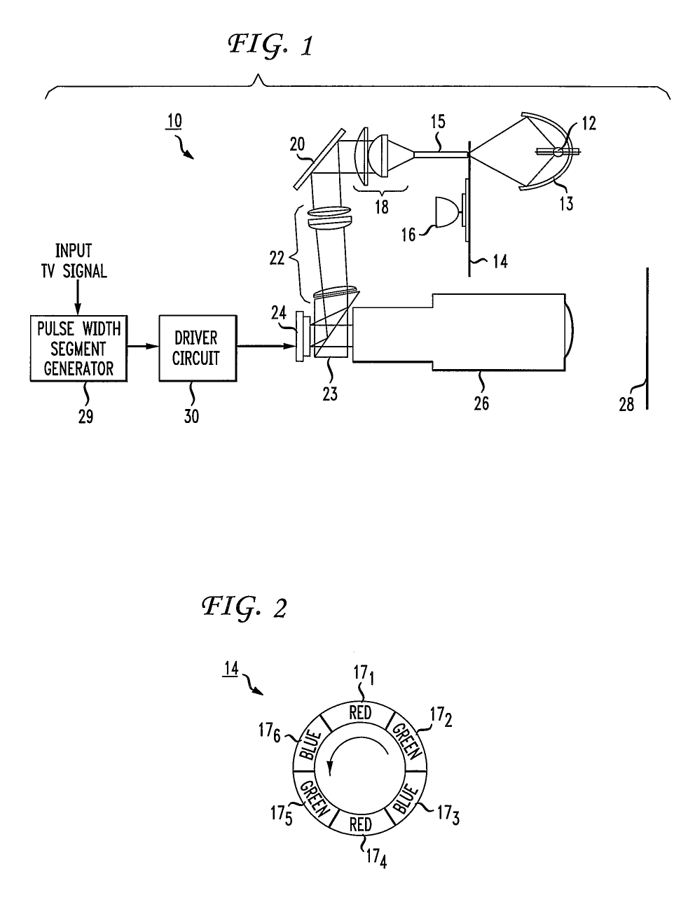

FIG. 1 depicts a present-day color sequential display system 10 of the type disclosed in the Application Report “Single Panel DLP™ Projection System Optics” published by Texas Instruments, June 2001 and incorporated by reference herein. The system 10 comprises a lamp 12 situated at the focus of an elliptical reflector 13 that reflects light from the lamp through a color wheel 14 and into an integrator rod 15. A motor 16 rotates the color wheel 14 to place a separate one of red, green and blue primary color windows between the lamp 12 and the integrator rod 15. In an exemplary embodiment depicted in FIG. 2, the color wheel 14 has diametrically opposed red, green and blue color windows 17₁ and 17₄, 17₂ and 17₅, and 17₃ and 17₆, respectively. Thus, as the motor 16 rotates the color wheel 14 of FIG. 2 in a counter-clockwise direction, red, green and blue light will strike the integrator rod 15 of FIG. 1 in an RGBRGB sequence. In practice, the motor 16 rotates the color wheel 14 at a sufficiently high speed so that during each picture interval, red, green and blue light each strikes the integrator rod 4 times, yielding 12 color images within the picture interval. Other mechanisms exist for successively imparting each of three primary colors. For example, a color scrolling mechanism (not shown) could perform this task as well.

Referring to FIG. 1, the integrator rod 15 concentrates the light from the lamp 12, as it passes through a successive one of the red, green and blue color windows of the color wheel 14, onto a set of relay optics 18. The relay optics 18 spread the light into a plurality of beams that strike a fold mirror 20, which reflects the beams through a set of lenses 22 and onto a Total Internal Reflectance (TIR) prism 23. The TIR prism 23 reflects the parallel light beams onto a Digital Micromirror Device (DMD) 24, such as the DMD device manufactured by Texas Instruments, for selective reflection into a projection lens 26 and onto a screen 28.

The DMD 24 takes the form of a semiconductor device having a plurality of individual mirrors (not shown) arranged in an array. By way of example, the DMD manufactured and sold by Texas Instruments has a micromirror array of 1280 columns by 720 rows, yielding 921,600 pixels in the resultant picture projected onto the screen 28. Other DMDs can have a different arrangement of micromirrors. As discussed previously, each micromirror in the DMD pivots about a limited arc under the control of a corresponding driver cell (not shown) in response to the state of a binary bit previously latched in the driver cell. Each micromirror rotates to one of a first and a second position depending on whether the latched bit applied to the driver cell, is a “1” or a “0”, respectively. When pivoted to its first position, each micromirror reflects light into the lens 26 and onto the screen 28 to illuminate a corresponding pixel. While each micromirror remains pivoted to its second position, the corresponding pixel appears dark. The interval during which each micromirror reflects light through the projection lens 26 and onto the screen 28 (the micromirror duty cycle) determines the pixel brightness.

The individual driver cells in the DMD 24 receive drive signals from a driver circuit 30 of a type well known in the art and exemplified by the circuitry described in the paper “High Definition Display System Based on Micromirror Device”, R. J. Grove et al. International Workshop on HDTV (October 1994) (incorporated by reference herein.). The driver circuit 30 generates drive signals for the driver cells in the DMD 24 in accordance with pixel signals supplied to the driver circuit by a processor 29, depicted in FIG. 1 as a “Pulse Width Segment Generator.” Each pixel signal typically takes the form of a pulse width segment comprised a string of pulses of different time duration, the state of each pulse determining whether the micromirror remains on or off for the duration of that pulse. The shortest possible pulse (i.e., a 1-pulse) that can occur within a pulse width segment (some times referred to as a Least Significant Bit or LSB) typically has a 15-microsecond duration, whereas the larger pulses in the segment each have a duration longer than the LSB interval. In practice, each pulse within a pulse width segment corresponds to a bit within a digital bit stream whose state determines whether the corresponding pulse is turned on or off. A “1” bit represents a pulse that is actuated (turned on), whereas a “0” bit represents a pulse that is de-actuated (turned off).

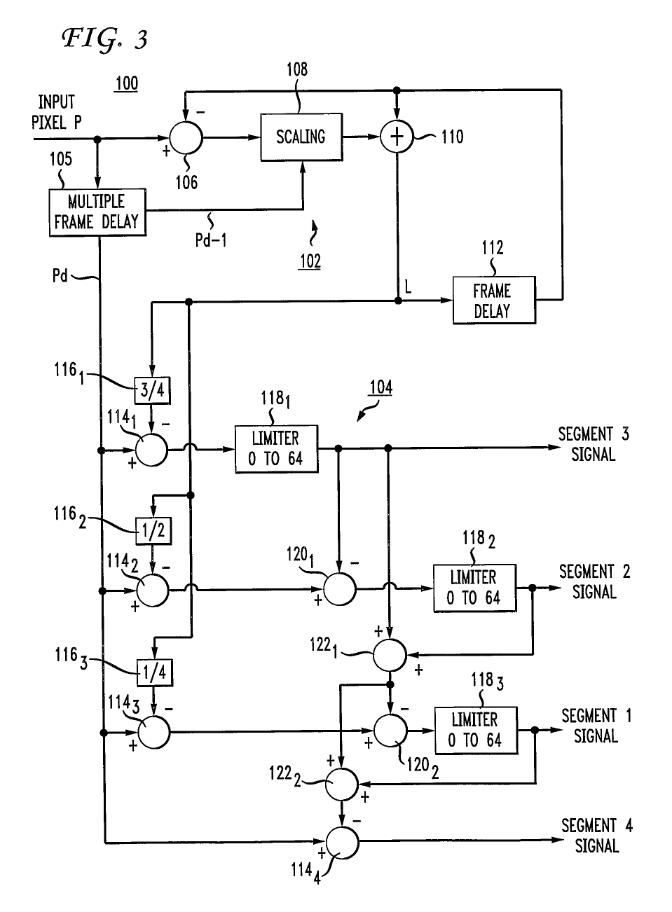

FIG. 3 depicts a block schematic diagram of a system 100 in accordance with a preferred embodiment of the present principles for providing pixel signals to the driver circuit 30 of FIG. 1 to control distribution of light in the display for each of the pixels in accordance with motion. For purposes of the present discussion, motion is defined as the change in the pixel signal from picture to picture (frame-to-frame) for a given pixel whose position within the image remains invariant. In other words, the intensity, but not the position of the pixel changes in response to motion. As discussed in greater detail below, the system 100 advantageously determines whether motion is present, and if so, the apparatus processes the pixel signal for the corresponding pixel undergoing motion to initially substantially confine the change in the illumination to a limited interval of the picture period. For purposes of discussion, the term “pixel illumination” defines the light produced by a pixel on the viewing screen. Confining the change in pixel illumination to a limited interval when motion is present reduces the incidence of motion blurring. In the absence of motion for more than a predetermined duration, the system 100 processes the pixel signal to cause a substantially uniform distribution of illumination throughout the picture period for the associated pixel. Spreading the illumination substantially equally throughout the picture period minimizes color break-up with random, large and fast eye motion.

As discussed above, the system of FIG. 3 provides pixel signals for all pixels for all frames, and typically does so by processing the pixels individually in a raster scan manner. To simplify the discussion of the system of FIG. 3, the processing of a single pixel will be discussed. Referring to FIG. 3, the apparatus 100 comprises a temporal low-pass filter portion 102 and a processing portion 104, responsive to the output signal of the temporal low-pass filter portion for splitting a frame-delayed representation of the incoming pixel signal into control signals, each controlling an individual segment for a given color for a corresponding pixel. In the illustrative embodiment, the sequential display system 10 of FIG. 1 comprises a “4×” system that displays each of three primary colors four times per incoming picture. Thus, each pixel in the incoming picture comprises four segments of three primary colors each. Accordingly, for each pixel, the processing portion 104 generates signals S1, S2, S3, and S4 for controlling the illumination of segments #1, #2, #3, and #4, respectively, for a given color for a given pixel.

The temporal low-pass filter portion 102 receives the incoming pixel signal P at its input, representing the illumination of an associated pixel, and in response, generates a delayed pixel signal Pd, corresponding to a multiple frame-delayed representation of the pixel signal. The temporal low-pass filter portion 102 also generates a temporal low-pass-filtered signal representation (L) of the pixel signal P. To generate the delayed pixel signal Pd, a delay block 105 delays the pixel signal P by multiple frames (typically four frames), yielding the signal Pd at its output. To generate the temporal low-pass signal L, the temporal low-pass filter portion 102 includes a first summing block 106 having an invert (−) and non-invert (+) inputs. At its non-invert input, the summing block 106 receives the input pixel signal P, whereas the invert input receives the output of a frame delay circuit 112. A scaling block 108 processes the output signal from the summing block 106 and a signal P_{d-1} (one frame less than P_{d}) the output from the multiple frame delay block 105 in a manner described hereinafter to yield an output signal for summing at a summing block 110 with the output of the frame delay block 112 which is supplied at its input with the output signal of the summing block 110. The output signal of the summing block 110 forms the temporal low-pass filtered signal L and the input to the frame delayed circuit 112 which delays the signal at its input by one frame.

In its simplest form, the scaling block 108 can take the form of a multiplier for multiplying the pixel signal by a constant K, typically 3/32 so that temporal low-pass-filtered signal L will equal the sum of the frame-delayed signal L and the difference between the input signal and the frame-delayed signal L, as scaled by the constant K.

To achieve the desired goal of confining the change in illumination from one frame to the next in as few time-adjacent segments as possible for the same color, the temporal low-pass filtered signal L should change faster for small amplitude changes than could otherwise be achieved by simply configuring the block 108 as a multiplier. In the illustrated embodiment of FIG. 3 the scaling block 108 includes the combination of an integer multiplier, such as described above, plus a clipper circuit that serves to clip the incoming signal from the summing block 106 when the value is above or below a predetermined threshold value to yield an integer positive or negative value, respectively. The output of this clipper circuit is summed with the output of the multiplier to yield the signal supplied to the summing block 110. The processing block 108 also carries out certain dynamic range limiting to prevent the value of L from becoming larger than the value of the incoming pixel signal P, or smaller than zero and to optimize the anticipation as described later. The temporal low-pass filtered signal L produced at the output of the summing block 110 will tend to lag the value of the pixel signal P when the latter changes due to motion. In a preferred embodiment for an eight-bit system, the summing blocks 106 and 110 and scaling block 108 collectively operative to generate the temporal low-pass filter signal L in accordance with the relationship:

Lₜ=MAX((2*Pd_{d-1}−255),MIN((2*P_{d-1}),INT(Lₜ₋₁+(Pₜ−Lₜ₋₁)/10.67+IF(Pₜ−Lₜ₋₁>4,4,IF(Pₜ−Lₜ₋₁<−3,−4,Pₜ−Lₜ₋₁))))) (Equation 1)

The processing portion 104 includes four invert summing blocks 114₁-114₄, each supplied at its respective non-invert (+) input with the delayed pixel signal Pd. The invert input (−) of each of the summing blocks 114₁-114₃ receives the output of a separate one of multipliers 116₁-116₃, respectively, each supplied at its input with the temporal low-pass filtered signal L produced by the temporal low-pass filter section 102. The multipliers 116₁-116₃ have multiplication factors of ¾, ½, and ¼, respectively. A first limiter 118₁, having a range of 0-64, limits the output signal of the summing block 114₁ to no more than 64 LSB and no less than zero. The output signal of the limiter 118₁ serves as the Segment 3 control signal (hereinafter referred to as signal S3) that controls segment #3 in accordance with the relationship Pd−¾L, as limited by the limiter 118₁.

To generate the Segment 2 control signal (S2) for controlling segment #2, a summing block 120₁ has its non-invert (+) input supplied with the output signal of the summing block 114₂. The -invert input (−) of the summing block 120₁ receives the output signal of the limiter 118₁. A limiter 118₂, having a limiting range of 0-64, limits the output signal of the summing block 120₁ to no more than 64 LSB and not less than zero. The output signal of the limiter 118₂ serves as the signal S2 that controls segment #2 in accordance with relationship (Pd−½L)−S3, as limited by the limiter 118₂.

To generate the Segment 1 control signal (S1) for controlling segment #1, a summing block 120₂ is supplied at its non-invert (+) input with the output signal of the summing block 114₃. The summing block 120₂ has its invert input (−) supplied with the output signal of a summing block 122₁ which has its first and second non-invert inputs (+) supplied with the output signals of limiters 118₁ and 118₂, respectively. A limiter 118₃ having a limiting range of 0-64 limits the output signal of the summing block 120₂ to no more to 64 LSB and no less than zero. The output signal of the limiter 118₃ serves as the signal S1 that controls segment #1 in accordance with the relationship (Pd−¼L)−(S3+S2) as limited by the limiter 118₃.

The Segment 4 control signal (S4) for controlling segment #4 emanates from the summing block 114₄ which receives the output signal of a summing block 122₂ supplied at each of its first and second non-invert inputs (+) with the output signal of the limiter 118₃ and the summing block 122₁, respectively. In this way, the output signal of the summing block 114₄ (S4) varies in accordance with the relationship Pd−(S3+S2+S1) which requires no limiting.

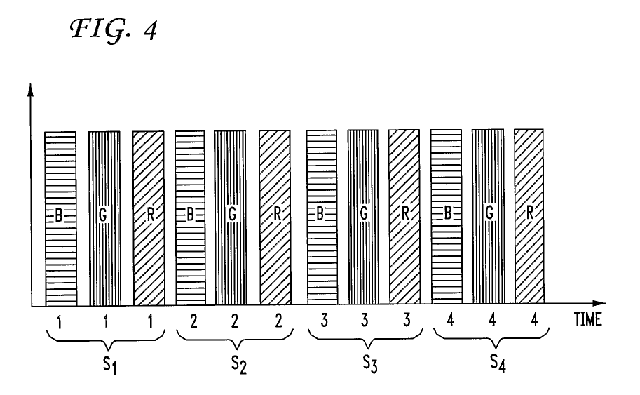

FIG. 4 shows a 4× sequential display having four segments #1, #2, #3, and #4, per picture period, each segment comprised of three primary colors (red, green and blue). The signals S1, S2, S3 and S4 control the segments #1, #2, #3, and #4 respectively for a given color for a given pixel for all pixels. Assuming a picture period of 1/60 second, with and subtracting the transition intervals, each segment will have a duration of about 1 millisecond.

The manner in which the circuit 100 of FIG. 3 provides an improved picture in accordance with the present principles can be understood as follows. In the absence of motion for a predetermined number of frames for a given pixel, then L=Pd and S1≅S2≅S3≅S4≅¼ Pd for integer values within one LSB of each other. In this way, the illumination for that pixel occurs equally throughout the picture period, which is desirable for minimizing color breakup with random, large, and fast eye motion. If motion occurs that results in a change in the value of P from frame to frame, then L will not equal Pd. Under such circumstances, the apparatus 100 seeks to initially substantially confine change in illumination first to segment #3, but if the change (as measured by the difference in LSB) becomes too great for a single segment, then the change in the illumination is confined to segments #3 and #2, the next successive segment in time. If too large for segments #3 and #2, the change in illumination will be confined to segments #3, #2, and #1. For a change in illumination larger than can be accommodated by segments #3, #2, and #1, the change will be accommodated using all of the segments (i.e., segments #3, #2, #1, and #4).

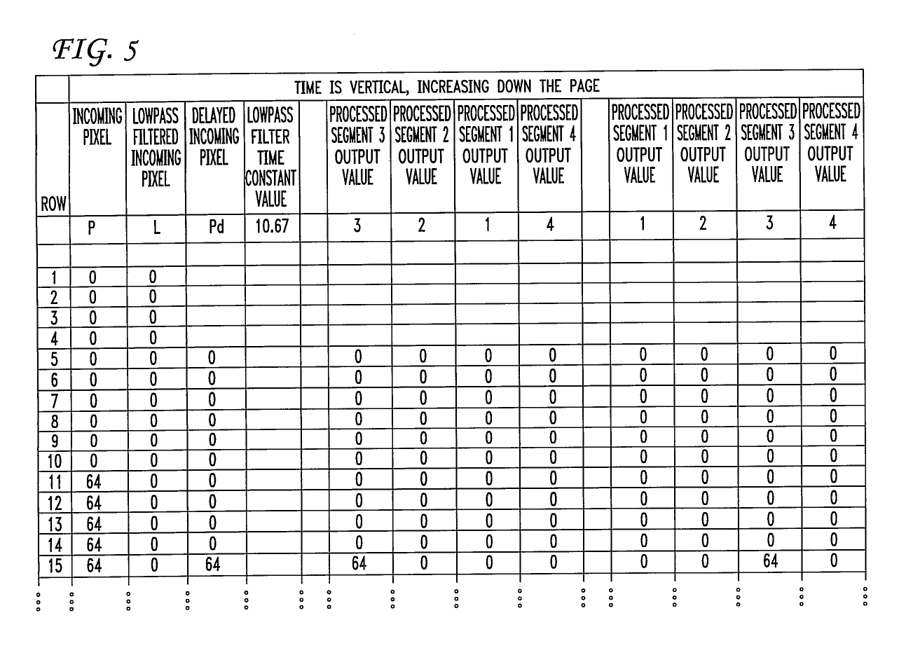

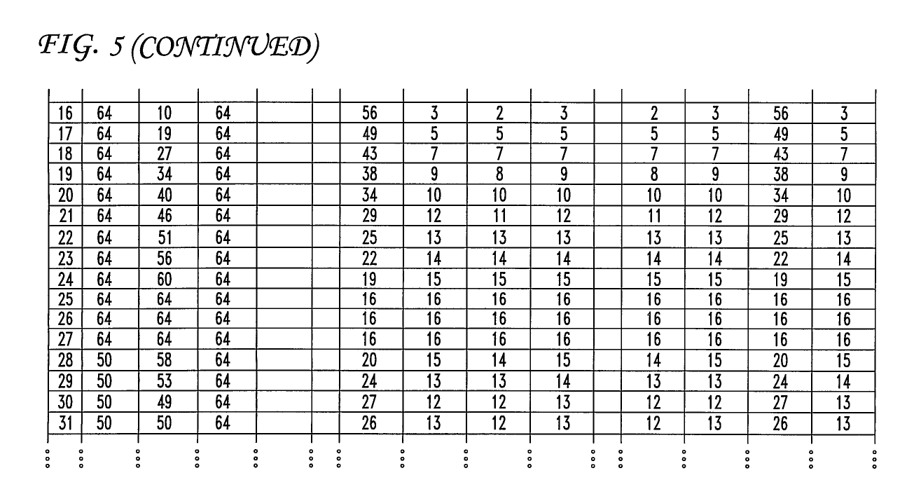

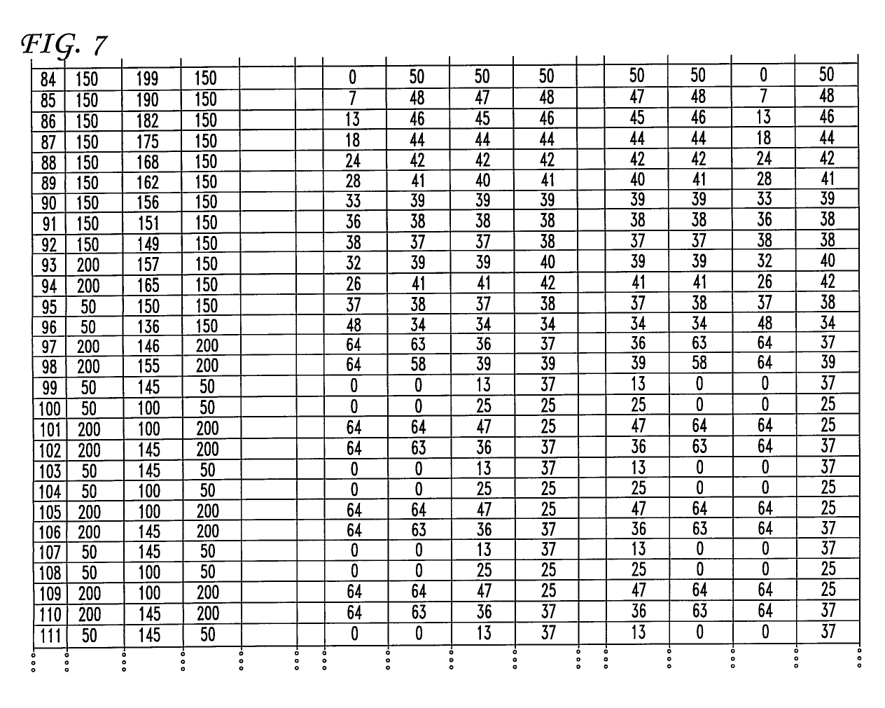

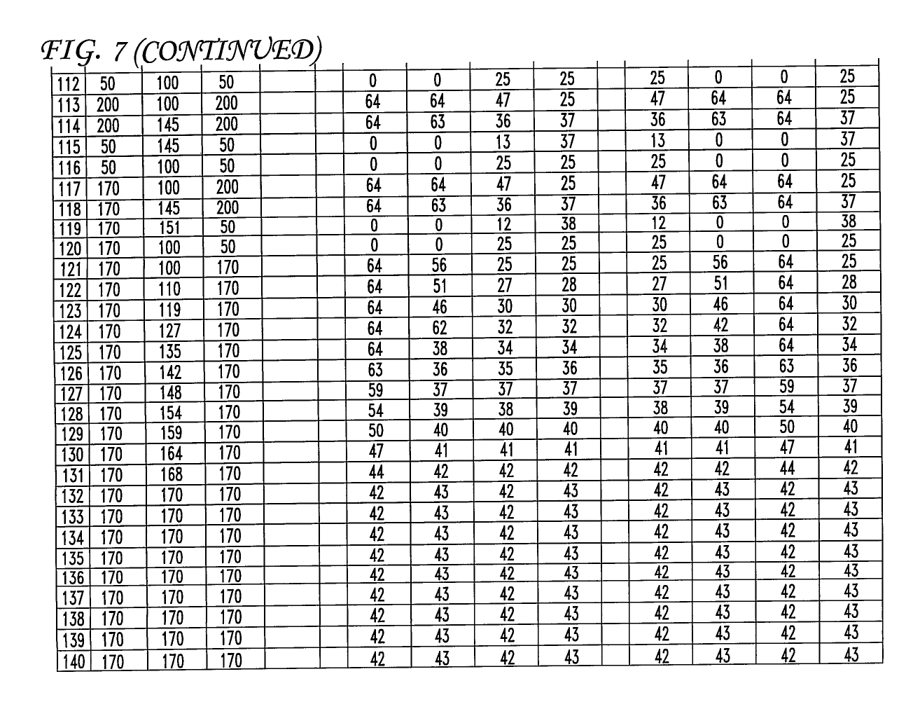

FIGS. 5-7 collectively illustrate a table of values for the temporal low-pass filtered pixel signal (L) value, the delayed pixel signal Pd, and resultant values for segments #1, #2, #3 and #4 (as measured in LSBs) produced by the apparatus 100 of FIG. 3 for successive values in successive frame periods of the incoming pixel signal P for a given pixel position, when the processing block 108 is configured in the manner previously described. As discussed, the temporal low-pass filter portion 102 of apparatus 100 of FIG. 3 generates the delayed pixel signal Pd by delaying the incoming pixel P signal by several frames (typically 4 frames in a preferred embodiment.) The fact that the temporal low-pass filter signal L changes in advance for a change yet to come in the delayed pixel signal Pd enables the pixel signal processing portion 104 of the apparatus 100 to anticipate a change in the incoming pixel signal P and prepare the segments #1-#4 in advance to help confine the change in illumination to a single segment (i.e., segment #3), but if too large, then to as few time-adjacent segments as possible.

To appreciate the operation of the apparatus 100 of FIG. 3, assume the incoming pixel signal for a given color for a given pixel starts at zero, as indicated by the incoming pixel value for a first frame corresponding to Row 1 of FIG. 5. With the incoming Pixel signal (P) at zero and assuming a history of P such that the temporal low-pass-filtered Pixel signal L is zero, then the delayed pixel signal Pd will also have a zero value. Under such circumstances, the signals S3, S2, S1, and S4 have zero values, yielding zero values for the segments #3, #2, #1 and #4, respectively. Assume that the incoming Pixel signal P remains at a zero value for a number of frames, corresponding to the zero value entries for the incoming pixel signal P in rows 1-10. Again, with the incoming pixel signal at a zero during this time, the delayed pixel signal Pd and the segments #3, #2, #1, and #4 remain all zero during this time, as evidenced by the zero values in Rows 1-7.

Now, assume that the pixel signal P jumps to a value of 64 LSB for a given color during the interval corresponding to Row 11 in FIG. 5. (Such a jump stems from the occurrence of motion.) As discussed, the temporal low-pass filter portion 102 of the apparatus of FIG. 3 time-delays the signal Pd so even though the incoming pixel value p has reached 64, the value of Pd remains zero until four frames later. Thus, only after a later interval (corresponding to Row 15 in FIG. 5) will the delayed pixel signal Pd reach a value of 64 LSB, corresponding to the value of the incoming pixel signal P four frames earlier. Note that the MIN term of the equation 1 serves to keep the value of L at zero during this time. In response to this change in the pixel signal, the apparatus 100 of FIG. 3 seeks to initially confine the change in illumination to segment #3, (as evidenced by 64 LSB value appearing for segment #3 in row 15 of FIG. 5.

Assume for purposes of discussion that the incoming pixel signal P remains constant at 64 LSB for an extended interval, corresponding to the interval between rows 11-28, representing an absence of motion. As discussed above, the in the absence of motion, the apparatus 100 seeks to equalize the values for segments #1-#4. As can be appreciated, with the incoming pixel signal constant during the interval between rows 11-25, the delays pixel signal Pd now also remains constant between rows 15-25. Over time, the low pass filtered pixel signal L starts to increase, ultimately reaching the value of 64 LSB in row 27.

The increasing value of L from row 16 through row 25 enables the apparatus 100 to prepare to generate equal segment values during the long interval while the incoming pixel value remains at 64 LSB. As seen in FIG. 5, segment #3 initially accommodated the entire 64 LSB change in pixel brightness between rows 14 and 15. However, during the interval that the incoming pixel signal remains constant at a 64 LSB value, the LSB value of segment #3 begins to drop as the apparatus begins to prepare the remaining segments #1, #2 and #4 to increase in value. As between row 16 through row 25, the value of segment #3 drops while each of segments #1, #2 and #4 all increase. Finally, at row 25, all of the segments reach 16 LSB, thus achieving equal value.

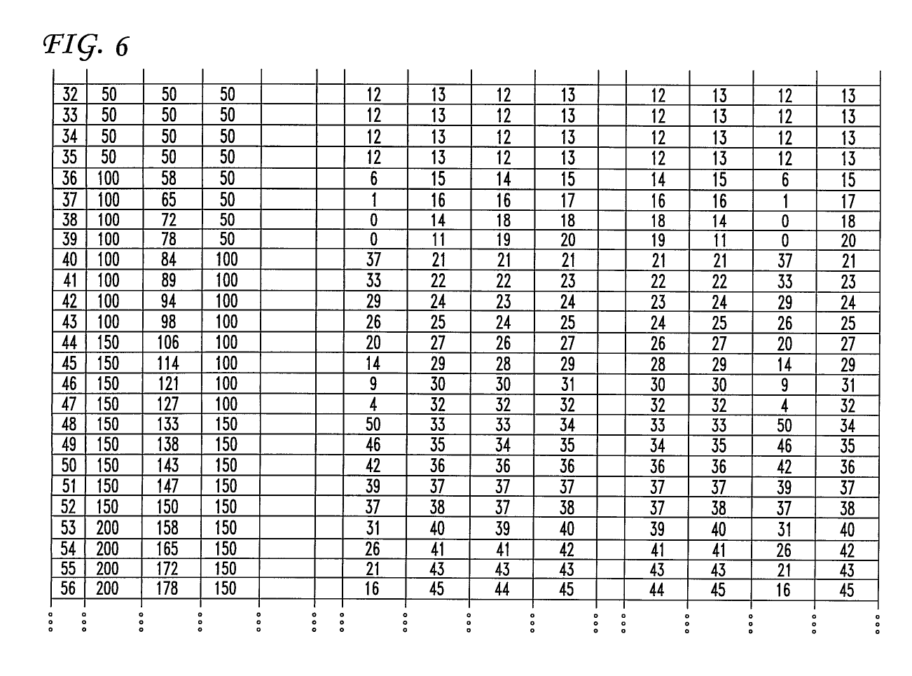

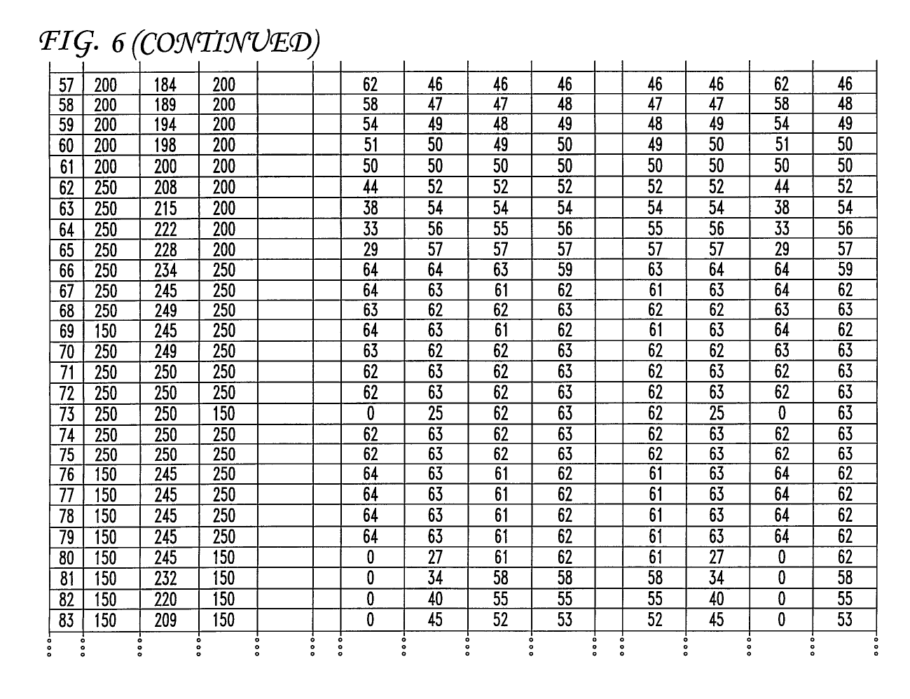

Now, consider the operation of the apparatus 100 of FIG. 3 when the input pixel signal P, which had previously been at a value of 150 LSB suddenly jumps to a value of 200 LSB as occurs during the interval between rows 52-53 in FIG. 6. Even though the incoming pixel signal P has jumped to 200 LSB at row 53, the delayed pixel signal Pd does not increase to 200 LSB until row 57. Immediately prior to the increase in the incoming pixel P at row 53, the values for segments #3, #2, #1 and #4 were 37, 38, 37, and 38, respectively, at row 52. To prepare the segments for the jump that has just occurred in the incoming pixel signal at row 53, the apparatus 100 begins to decrease the value of segment #3 from a value its value of 37 LSB in row 52 to a value of 16 LSB in row 56. In this way, segment #3 can absorb a 50 LSB increase in value when the value of Pd finally increases to 200 LSB in row 57. In this way, the system 100 of FIG. 3 enables segment #3 to accommodate nearly all the change in pixel brightness.

The system 100 of FIG. 3 operates equally effectively to prepare the segments for a decrease in illumination, which can be appreciated by examining the values reflected in rows 27 through 32 of FIG. 5. At row 27 the incoming pixel signal P has a value of 64 LSB, which drops to 50 LSB at row 28 and remains at 50 LSB through row 32. With the pixel signal P at 64 LSB at row 27, and with the value of L now at 64 LSB in row 27, the segments #3, #2, #1, and #4 all have the value of 16 LSB at this time. Now assume a drop in the incoming pixel signal P to 50 LSB as indicated in row 28. To prepare for this decrease of 14 LSB, the system 100 of FIG. 3 begins by increasing the value of segment #3 in row 28 to 20 LSB, while causing each of segments #2, #1, and #4 to drop to 15, 14 and 15 LSB, respectively. As between rows 29-31, the segment #3 increases in brightness to 26 LSB, while the segments #2, #1, and #4 continue to drop in brightness, until row 32, at which time, the brightness level of segment #3 drops to 12 LSB, to reach approximately the same value (within 1 LSB) as segments #2, #1, and #4 which have already dropped to the levels of 13, 12 and 13 LSB, respectively, at this time. In this way, the system 100 of FIG. 3 has sought to confine substantially the change in brightness to as few time adjacent segments as possible.

A good example how system 100 of FIG. 3 apportions a large change in illumination to as few segments as possible can be seen by examining the change in values in rows 75-92. Assume a decrease from 250 LSB to 150 LSB in the incoming signal P, as occurs between rows 75 and 76 in FIG. 6. At the interval corresponding to row 75, the segments #3, #2, #1 and #4, have values of 62, 63, 62 and 63 LSB, respectively. Given the several frame delay between the incoming pixel signal P and the delayed pixel signal Pd, the value of Pd does not decrease to 150 LSB until row 80, whereupon, the apparatus 100 of FIG. 2 decreases the value of segment #3 to 0 LSB to accommodate at least part of the decrease in the incoming pixel signal P. Since the decrease in the incoming pixel signal P is greater than 64 LSB (the maximum value that can be accommodate by segment #3 alone), the value of segment #2 is decreased by 36 LSB at row 80. During the relatively long interval between rows 80-92 that incoming pixel signal P remains constant at 150 LSB (i.e., no motion), the apparatus 100 ultimately equalizes the segments values so that at row 92, the segments #3, #2, #1, and #4 become 38, 37, 37, and 38 respectively.

The foregoing describes a technique for operating a sequential display to reduce artifacts and enhance the sharpness of moving objects in the display.

1. A method for operating a color sequential display system having at least one pixel controlled by a pixel signal that determines pixel illumination during each of a plurality of segments of a picture period; comprising the steps of:
determining from the pixel signal whether motion has occurred, and if so,
then processing the pixel signal to initially substantially confine the change in illumination to a limited number of time-adjacent segments of an identical color to reduce motion blurring.

2. The method according to claim 2 wherein in the absence of motion for more than a predetermined period, the pixel signal is processed to cause a substantially uniform distribution of illumination among the segments.

3. The method according to claim 1 wherein the step of determining from the pixel signal whether motion has occurred further comprises the step of comparing the pixel signal to a prior pixel value delayed by a prescribed interval.

4. A method for operating a sequential display system having at least one pixel controlled by a pixel signal that determines pixel illumination during each of a plurality of segments of a picture period, comprising the steps of:
determining from the pixel signal whether motion has occurred, and if so,
then processing the pixel signal to initially substantially confine the change in illumination to a limited number of time-adjacent segments of an identical color to reduce motion blurring, but in the absence of motion for more than a predetermined period,
processing the pixel signal to cause a substantially uniform distribution of illumination among the segments.

5. The method according to claim 4 wherein the step of determining from the pixel signal whether motion has occurred for the associated pixel further comprises the step of comparing the pixel signal to a prior pixel value delayed by a prescribed interval.

6. A sequential display system having pixels, each pixel controlled by a pixel signal that determines pixel illumination during each of a plurality of segments during a picture period;
means for determining from the pixel signal whether motion has occurred, and
means for processing the pixel signal to initially substantially confine the change in illumination due to motion to a limited number of time-adjacent segments of an identical color to reduce motion blurring when motion has occurred.

7. The apparatus according to claim 6 wherein in the absence of motion for more than a predetermined period, the pixel signal processing means processes the pixel signal to substantially uniformly distribute illumination among the segments.

8. The display system according to claim 6 wherein the motion determining means includes a temporal low-pass filter.
